(19) United States
(12) Patent Application Publication
(10) Pub. No.: US 2021/0078111 A1
(43) Pub. Date: Mar. 18, 2021

(54) METAL PARTICLE

(71) Applicant: NAPRA CO., LTD., Tokyo (JP)

(72) Inventor: Shigenobu SEKINE, TOKYO (JP)

(21) Appl. No.: 16/571,799

(22) Filed: Sep. 16, 2019

(51) Int. Cl. B23K 35/26; C22C 13/00; C22C 9/02; C22C 1/04; C22C 1/02; B23K 35/30; B23K 35/02; B22F 9/08

(52) U.S. Cl. CPC B23K 35/262; C22C 13/00; C22C 9/02; C22C 1/0491; B22F 2303/15; B23K 35/302; B23K 35/025; B22F 9/082; B22F 2301/30; C22C 1/02

(57) ABSTRACT

Disclosed is a metal particle that includes Cu and Sn, the metal particle having a metal matrix composed of Sn—Cu alloy, and a nano-sized intermetallic compound composed of Cu and Sn, and the metal particle having at least inside thereof an alloyed structure in which the metal matrix and the intermetallic compound form an endotaxial junction.

### INCORPORATION BY REFERENCE

This application is based on Japanese Patent Application No. 2017-152429, filed on Aug. 7, 2017, the content of which is incorporated hereinto by reference.

### BACKGROUND OF THE INVENTION

### 1. Field of the Invention

This invention relates to a metal particle suitably used for forming a bonding part where a metal body or an alloy body (metal/alloy body) is bonded.

### 2. Description of the Related Art

Devices that are kept operated at high temperatures over a long period, and also used under harsh environments such as causing large temperature change between operation at high temperatures and idling at low temperatures, represented by vehicle-borne power control device (power device), are required to keep high bonding strength of the bonding part over a long period, irrespective of such thermal history. Known bonding materials have, however, not always been capable of satisfying the requirement.

For example, a SnAgCu-based bonding material (powder solder material) disclosed in JP-A-2007-268569 is far from attaining the goal of such requirement.

There is also known a problem inherent to bonding, observed as decrease of mechanical strength due to Kirkendall void. Kirkendall void appears when atomic vacancies (lattice defects) caused by unbalanced mutual diffusion of metals accumulate, rather than annihilate. Referring for example to an interface between Sn and Cu, vacancies are found to accumulate at the interface between intermetallic compound and Cu, to form Kirkendall void. Such Kirkendall void grows up into larger void or crack, possibly degrading reliability and quality of the bonding part, and even reducing mechanical strength to cause separation, breakage, rupture and so forth.

For example, JP-A-2002-261105 discloses a technology by which an electrode on a semiconductor device and an electrode on a mounting substrate are connected via a bonding part having Cu₆Sn₅ and Cu balls, wherein also Cu balls are mutually connected by Cu₆Sn₅.

JP-A-2014-199852 discloses a method by which a bonding material that contains a Cu metal particle and an Sn particle is coated over a bonding face of a semiconductor chip or a substrate, Cu and Sn in the bonding material are then allowed to cause transient liquid phase sintering under heating at a temperature higher than the melting point of Sn, followed by further heating. The literature, however, does not disclose a means for suppressing Kirkendall void.

### SUMMARY OF THE INVENTION

It is therefore an object of this invention to provide a metal particle suitably used for forming a bonding part where metal bodies or alloy bodies (metal/alloy bodies) are bonded.

This invention, aimed at solving the aforementioned problem, includes the followings:

1. A metal particle that includes Cu and Sn, the metal particle having a metal matrix composed of Sn—Cu alloy, and a nano-sized intermetallic compound composed of Cu and Sn, and

the metal particle having at least inside thereof an alloyed structure in which the metal matrix and the intermetallic compound form an endotaxial junction.

2. The metal particle according to 1, wherein the intermetallic compound amounts 3% or more and 85% or less in the metal particle, in terms of ratio by volume.

3. The metal particle according to 2, wherein the intermetallic compound amounts 10% or more and 75% or less in the metal particle, in terms of ratio by volume.

### BRIEF DESCRIPTION OF THE DRAWINGS

FIG. 1 is an electron microphotograph of a sample of metal particle of this invention, with the surface slightly polished by laser polishing;

FIG. 2 is an enlarged electron microphotograph of the sample shown in FIG. 1;

FIG. 3 is a schematic drawing illustrating an exemplary bonding part;

FIG. 4 is an SEM image of area A in FIG. 3;

FIG. 5 is an SEM image enlarged from FIG. 4;

FIG. 6 is an image enlarged from the planar SEM image of area A in FIG. 3;

FIG. 7A is a schematic drawing illustrating an initial state of the metal particle before being melted, and FIG. 7B is a schematic drawing illustrating a state of solidification after transient liquid phase sintering (TLPS);

FIG. 8 is an optical microphotograph of a cross-sectional structure of the metal particle after melting and recombination;

FIG. 9 is an electron microphotograph of the metal particle of this invention, enlarging an intermetallic compound and a metal matrix;

FIG. 10 shows electron microphotographs of a cross section of a metal particle, in which Sn—Cu alloy composing the metal matrix forms an endotaxial junction with the intermetallic compound; and

FIG. 11 is a schematic drawing explaining an exemplary apparatus suitable for manufacturing the metal particle of this invention.

### DESCRIPTION OF THE EMBODIMENTS

This invention will be further detailed below.

First of all, the terms used in this specification are defined as follows.

(1) The term “metal” covers not only simple metal element, but occasionally covers also alloy, intermetallic compound, composite structure, or combinations of them containing a plurality of metal elements.

(2) The term “nano-” is used to describe a size smaller than 1 μm (1000 nm).

(3) The term “metal matrix” means a metal or alloy that serves as a base material when combined with other ingredient(s) to form a bulk.

(4) The term “alloyed structure” means a structure in which the metal matrix and the nano-sized intermetallic compound form an endotaxial junction.

(5) The term “endotaxial junction structure” means a structure in which a substance that forms metal or alloy has other substance (intermetallic compound) precipitated therein to form a crystal grain, while creating a lattice-matched junction between these substances (for example, between alloys, between metals, and between intermetallic compounds).

The metal particle used for composing the bonding part is composed of at least two or more kinds of metals having different melting points.

Chemical composition of the metal particle is properly selected depending on a mating material to be bonded. The metal particle may typically contain at least one low-melting-point metal and at least one kind of high-melting-point metal, selected from the group consisting of Cu, Al, Ni, Sn, Ag, Au, Pt, Pd, Si, B, Ti, Bi, In, Sb, Ga, Zn, Cr, Co, and rare-earth elements.

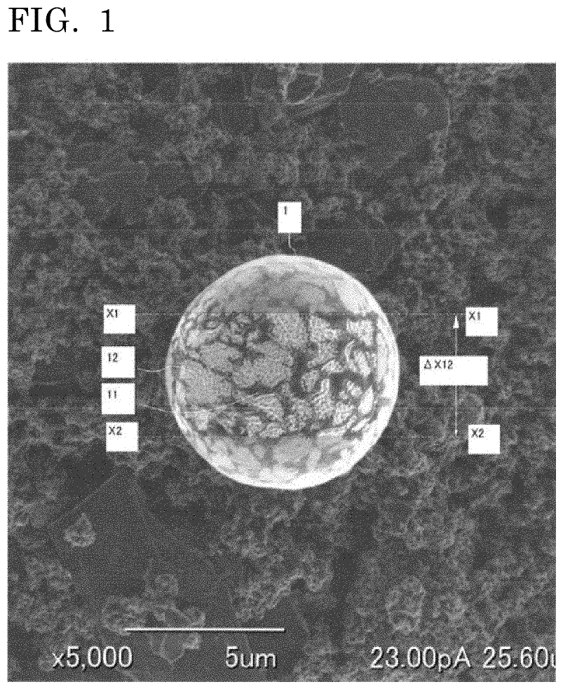

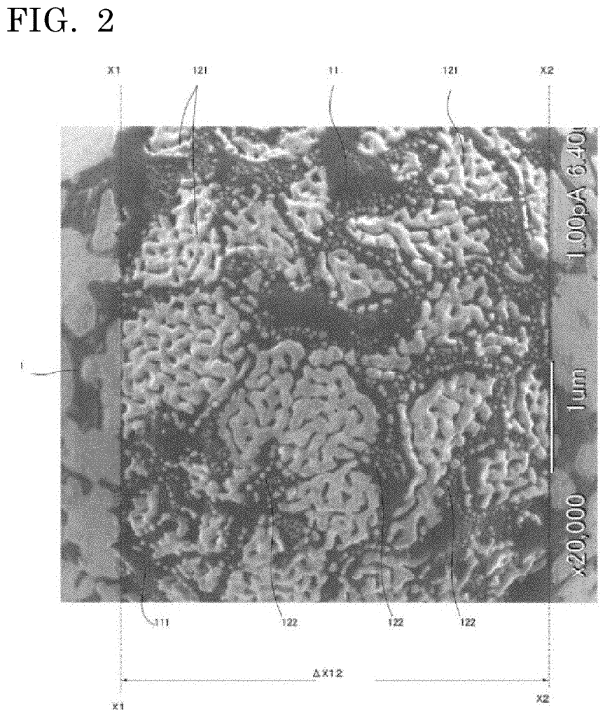

An explanation will be given below referring to an Sn alloy-containing metal particle with a chemical composition represented, for example, by 8% by mass of Cu and 92% by mass of Sn (denoted by “8Cu.92Sn”, hereinafter). Electron microphotographs of 8Cu.92Sn are shown in FIGS. 1 and 2.

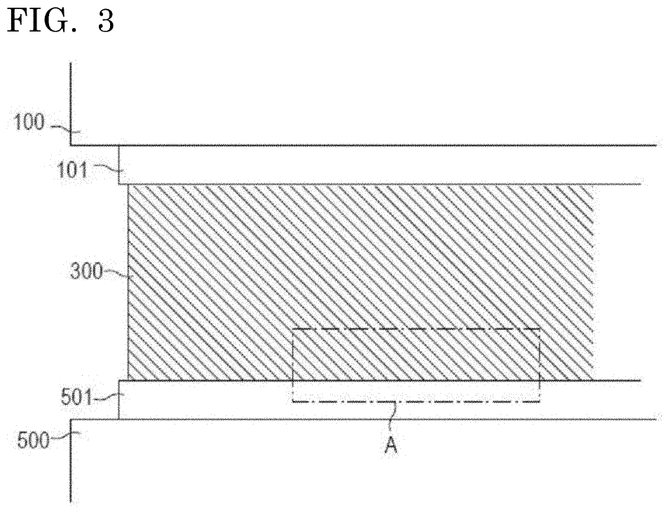

Depending on chemical compositions of metal/alloy bodies 101, 501 (see FIG. 3) to be bonded, a metal particle with a chemical composition of 8Cu.92Sn may be used solely by itself. Alternatively, 8Cu.92Sn may be used in the form of powder having a mixed chemical composition as a result of mixing with metal particle of SnAgCu-based alloy and/or metal particle of Cu. One specific chemical composition in this case is given by the metal particle of SnAgCu-based alloy adjusted within the range from 10 to 20% by mass, the metal particle of Cu adjusted within the range from the 10 to 20% by mass, and the balance of metal particle of 8Cu.92Sn.

The metal particle 1 of 8Cu.92Sn shown in FIG. 1 is found to have a particle size of 10 μm or smaller, as judged from the scale indicated in the photograph.

The metal particle 1 has an alloyed structure. The alloyed-structure will be detailed below, referring to electron microphotographs of FIGS. 1 and 2. FIGS. 1 and 2 are electron microphotographs of the metal particle 1 of 8Cu.92Sn, whose surface was slightly polished by laser polishing, over a width ΔX12 specified between line segments (X1-X1) and (X2-X2).

Referring first to FIGS. 1 and 2, intermetallic compound CuₓSn_{y} is found to appear with the forms of mesh 121, spot, and membrane 122, in the metal matrix that looks dark, over the surface of metal particle 1 of 8Cu.92Sn. An actual structure of the intermetallic compound CuₓSn_{y} is three-dimensional. Some of the intermetallic compound CuₓSn_{y} grains are found to have a size on the order of nanometer size (smaller than 1 μm), judging from the scale indicated in FIG. 2.

That is, the metal particle 1 contains a large number of nano-sized intermetallic compound grains that form a nanocomposite three-dimensional structure distributed in the metal matrix. Now the nanocomposite three-dimensional structure means a three-dimensionally structured crystal having a size equal to or smaller than one-tenth of the metal particle 1.

The metal particle 1 of 8Cu.92Sn has, as can be understood from FIGS. 1 and 2, the metal matrix and the nano-sized intermetallic compound, and has at least inside thereof an alloyed structure in which the metal matrix and the intermetallic compound Cu₆Sn₅ form the endotaxial junction (alloyed nanocomposite structure).

The alloyed structure, in which the metal matrix and the intermetallic compound form the endotaxial junction, appears as a result of precipitation, within the particle, of the intermetallic compound having been made into a nano-sized powder during manufacturing while forming the endotaxial junction with the metal matrix. In the metal particle 1 of this invention, the alloyed structure constructed by forming the endotaxial junction extends in a three-dimensional manner within the metal particle 1.

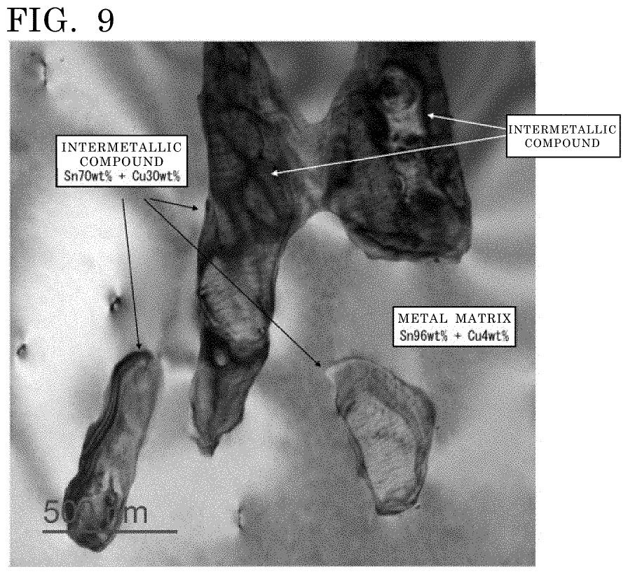

FIG. 9 is an electron microphotograph of the laser-polished metal particle shown in FIG. 1, enlarging the intermetallic compound and the metal matrix.

As seen in FIG. 9, the metal matrix contains Sn—Cu alloy. At the junction interface between the intermetallic compound and the metal matrix, there occurs a junction between Sn—Cu alloy and the intermetallic compound in a lattice-matched manner. That is, the endotaxial junction is formed.

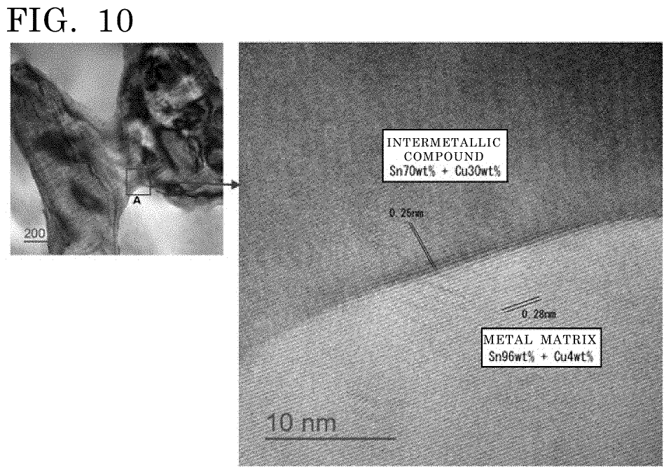

FIG. 10 shows electron microphotographs of a cross section of a metal particle, in which in the metal particle shown in FIG. 9, the Sn—Cu alloy composing the metal matrix forms the endotaxial junction with the intermetallic compound.

From FIG. 10, the junction at the interface between the Sn—Cu alloy composing the metal matrix and the intermetallic compound was observed to be the endotaxial junction.

With the alloyed structure given by formation of the endotaxial junction, the metal particle of this invention, when used for forming the bonding part of the base member, can produce therein a structure given by strongly-bound endotaxial junction between the intermetallic compound and the metal matrix as detailed later. Hence, the bonding part will therefore have good high temperature resistance, flexibility, bonding strength and mechanical strength, and can suppress generation of Kirkendall void.

The metal particle of this invention may have a shell and a core, wherein the core may contain the alloyed structure, and also the shell that covers the core may be substantially composed of such alloyed structure.

The alloyed structure may be formed by combinations other than the combination of Cu and Sn, such as combinations of at least one kind of low-melting-point metal and at least one kind of high-melting-point metal, selected from the group consisting of Cu, Al, Ni, Sn, Ag, Au, Pt, Pd, Si, B, Ti, Bi, In, Sb, Ga, Zn, Cr, Co, and rare earth elements.

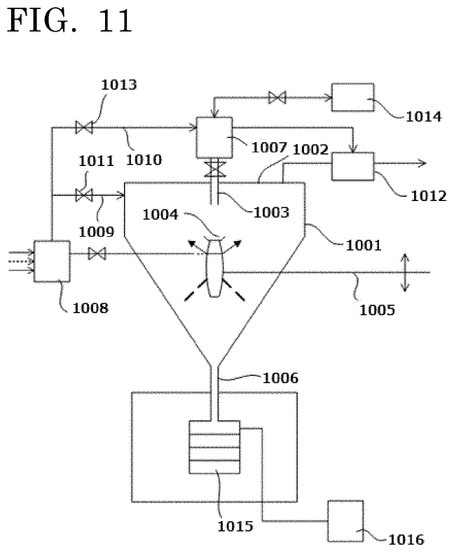

An exemplary manufacturing equipment suitable for manufacturing the metal particle of this invention is explained referring to FIG. 11. A granulation chamber 1001 has a cylindrical top part and a conical bottom part, and has a lid 1002 on the top. A nozzle 1003 is perpendicularly inserted at the center of the lid 1002, and a dish-type rotating disk 1004 is arranged directly below the nozzle 1003. Reference sign 1005 denotes a mechanism that moves up and down the dish-type rotating disk 1004. At the lower end of the conical bottom part of the granulation chamber 1001, there is connected a delivery pipe 1006 through which produced fine particles are output. The top end of the nozzle 1003 is connected to an electric furnace (high frequency induction furnace) 1007 that melts a metal to be granulated. An atmospheric gas controlled to contain predetermined ingredients in a mixed gas tank 1008 is fed through a pipe 1009 and a pipe 1010 respectively into the granulation chamber 1001 and to an upper part of the electric furnace 1007. Pressure in the granulation chamber 1001 is controlled by a valve 1011 and an exhaust apparatus 1012, meanwhile pressure in the electric furnace 1007 is controlled by a valve 1013 and an exhaust apparatus 1014. Molten metal fed through the nozzle 3 on the dish-type rotating disk 1004 is scattered by centrifugal force of the dish-type rotating disk 1004 to produce fine droplets, and then cooled under reduced pressure to produce solid particles. The thus produced solid particles are fed through the delivery pipe 1006 to an automatic filter 1015 and classified. Reference sign 1016 denotes a particle collection apparatus.

A process of solidifying the molten metal under cooling is important for allowing the metal matrix and the intermetallic compound to form the endotaxial junction.

Typical conditions are as follows:

dish-type rotating disk 1004: with a dish-type disk having an inner diameter of 60 mm, and a depth of 3 mm, rotated at 80,000 to 100,000 rpm; and

granulation chamber 1001: evacuated using a vacuum chamber with an evacuation performance up to 9×10⁻² Pa or around, feeding nitrogen gas at 15 to 50° C. while being concurrently evacuated, to keep the pressure inside the granulation chamber 1001 to 1×10⁻¹ Pa or below.

The metal particle manufactured under such conditions is 20 μm or smaller in diameter for example, which typically ranges from 2 μm to 15 μm.

When the metal particle 1 of 8Cu.92Sn, after processed into sheet or paste, is allowed to melt and solidify between two members to be bonded, the three-dimensionally structured intermetallic compound causes breakage and recombination, to thereby form a new three-dimensional structure of the intermetallic compound.

A preform sheet composed of the metal particle 1 is obtainable typically by subjecting a powder containing the metal particle 1 to an intermetal bonding process based on cold welding. The intermetal bonding process based on cold welding per se has been known with a wide variety of techniques. This invention can employ any of these known techniques. For example, a powder containing the metal particle 1 of this invention is fed between a pair of pressure contact rollers that rotate in opposite directions, and the powder is pressurized by the pressure contact rollers to cause intermetal bonding of the metal particle 1 that composes the powder. In a practical process, the powder is preferably heated to 100° C. or around through the pressure contact rollers. The preform sheet composed of the metal particle 1 is thus obtained.

Inside the preform sheet obtained by subjecting the powder containing the metal particle 1 to intermetal bonding process based on cold welding, the metal particle 1 of this invention 1 and other particles keep their internal structures almost intact, despite modification of the external shapes. In other words, the preform sheet has a nanocomposite structure that contains a nano-sized intermetallic compound composed of a plurality of metal ingredients. Hence, a molded article retains operations and effects of the metal particle of this invention in their intact forms.

Next, the preform sheet is placed between two members to be bonded, and then baked (baking process) to form the bonding part. Temperature of the baking process is 250° C. for example, and baking time is properly controlled.

Alternatively, in order to efficiently form a bonding layer 22 using the metal particle 1, the metal particle 1 may be dispersed in an organic vehicle to obtain an electroconductive paste.

The electroconductive paste is then coated on the surface of one of two members to be bonded, and then baked (baking process) to form the bonding part. Temperature of the baking process is 250° C. for example, and baking time is properly controlled.

Referring now to FIG. 3, a thus obtained bonding part 300 bonds, for example, metal/alloy bodies 101, 501 respectively formed on the substrates 100, 500 opposed to each other. The substrates 100, 500 are typically those composing electrical/electronic devices such as power device, meanwhile the metal/alloy bodies 101, 501 are electrodes, bumps, terminals, or lead conductors provided on, and integrally with, the substrates 100, 500. In the electrical/electronic devices such as power device, the metal/alloy bodies 101, 501 are usually composed of Cu or Cu alloy. This, however, does not preclude any components that correspond to the substrates 100, 500 from being composed of such metal/alloy bodies.

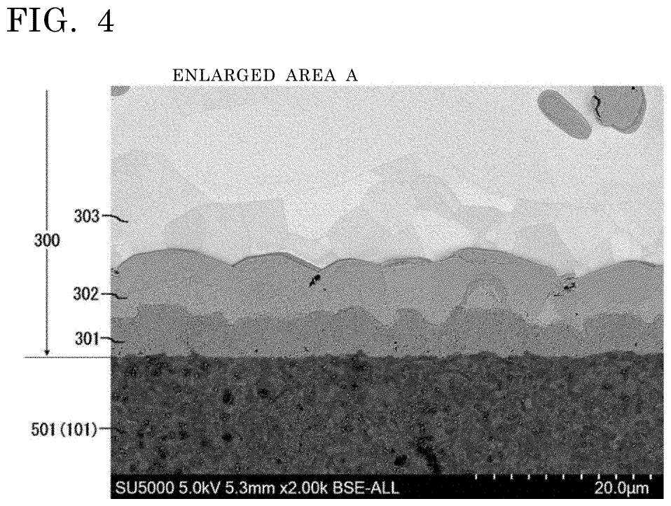

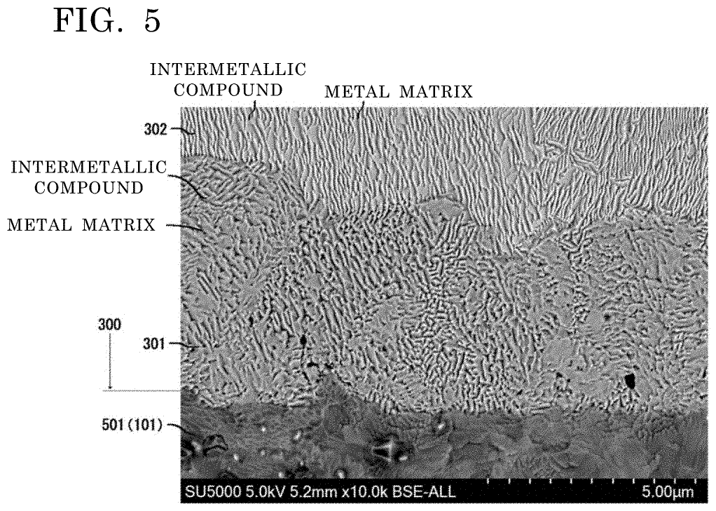

The bonding part 300 contains the intermetallic compound and the metal matrix. The intermetallic compound and the metal matrix form the nanocomposite structure. In the nanocomposite structure, the metal matrix of 200 nm or thinner lies between adjacent intermetallic compound grains, and the intermetallic compound grains of 200 nm or smaller lie in the metal matrix. The structure will be specifically explained below, referring to FIGS. 4 and 5.

Referring now to FIGS. 4 and 5, the bonding part 300 has a structure in which a first layer 301, a second layer 302 and a third layer 303 are stacked in this order on the surface of the metal/alloy bodies 101, 501. Each of the first layer 301 and the second layer 302 has the nanocomposite structure composed of the intermetallic compound and the metal matrix. In the first layer 301 and the second layer 302, areas that look like ridges of a maze seen in FIG. 5 correspond to the intermetallic compound, and areas that look like valleys of the maze correspond to the metal matrix.

Judging from the scale indicated in FIG. 5, there is confirmed the nanocomposite structure in which the metal matrix of 200 nm or thinner lies between the adjacent intermetallic compound grains, and the intermetallic compound grains of 200 nm or smaller lie in the metal matrix. In each of the first layer 301 and the second layer 302, the nanocomposite structure may be composed of a gathering of the intermetallic compound having a single crystal size of 200 nm or smaller, and the metal matrix having a crystal size of 200 nm or smaller.

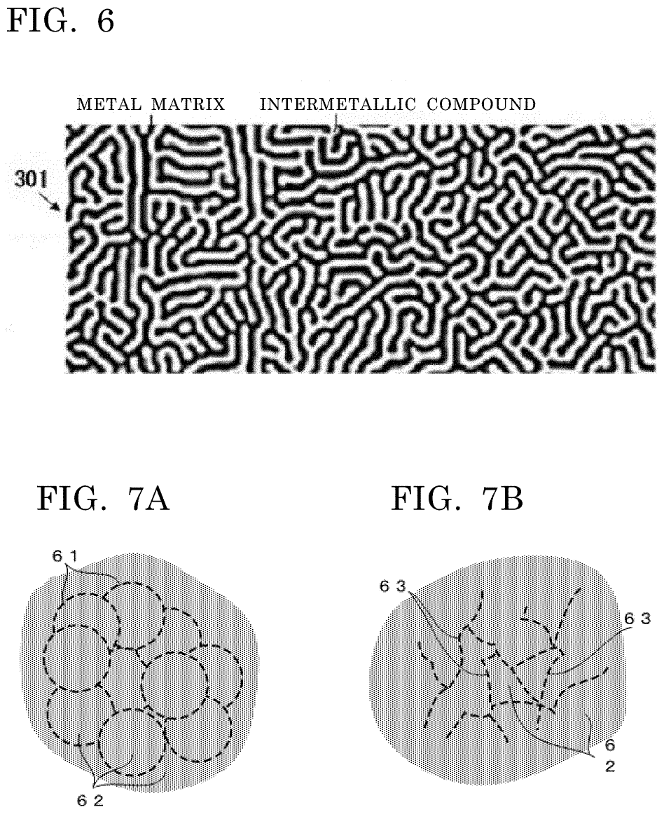

In the nanocomposite structure, the intermetallic compound contained in the first layer 301 and the second layer 302 has a three-dimensional structure. FIGS. 4 and 5 show the three-dimensional structure when viewed on the polished surface, and FIG. 6 shows the three-dimensional structure when viewed on a plane perpendicular to the polished surface, where a lamellar structure is observable.

Referring to FIGS. 4 and 5, the metal/alloy bodies 101, 501 are Cu layers. The bonding part 300 contains Sn as a low-melting-point metal ingredient, and a Cu as a high-melting-point metal ingredient having a melting point higher than that of Sn, and is bound to the surficial portion of the metal/alloy bodies 101, 501 which are Cu layers. Bonding between the metal/alloy bodies 101, 501 and the bonding part 300 is established by solid phase diffusion bonding.

In this structure, the first layer 301, adjoining to the metal/alloy bodies 101, 501 which are Cu layers, has a nanocomposite structure composed of Cu₃Sn as a Cu-rich intermetallic compound, and the metal matrix (Sn and several percent of CuₓSn_{y} alloy (x<y)). The second layer 302, away from the metal/alloy bodies 101, 501 which are Cu layers, has a nanocomposite structure composed of intermetallic compound Cu₆Sn₅, and the metal matrix. That is, the intermetallic compound CuₓSn_{y} has a compositional concentration gradient featured by larger Cu content x and smaller Sn content y at a position closer to the metal/alloy bodies 101, 501, conversely smaller Cu content x and larger Sn content y at a position away from the metal/alloy bodies 101, 501. Intermetallic compound Cu₃Sn and intermetallic compound Cu₆Sn₅ represent stable compositional regions of Cu and Sn in the aforementioned compositional concentration gradient.

Bonding between the first layer 301 and the second layer 302 is established by intermetallic diffusion bonding.

As described above, the bonding part 300 has the nanocomposite structure composed of the intermetallic compound and the metal matrix, and the nanocomposite structure is constructed so that the metal matrix of 200 nm or thinner lies between the adjacent intermetallic compound grains, and the intermetallic compound grains of 200 nm or smaller lie in the metal matrix. In such nanocomposite structure, the intermetallic compound forms a three-dimensional structure.

With such nanocomposite structure and the three-dimensional structure, the bonding part 300 per se is gifted with high temperature resistance attributable to the intermetallic compound that composes the first layer 301 and the second layer 302, and flexibility attributable to the metal matrix that composes the same. Hence, the bonding part can keep high heat resistance, bonding strength and mechanical strength over a long period, even when devices are kept operated under higher temperatures for a long duration of time, or even when used under harsh environments such as causing large temperature change between operation at high temperatures and idling at low temperatures.

It also becomes possible to form the bonding part 300 with high reliability and high quality, which is capable of suppressing Kirkendall void from occurring, excels in mechanical strength, and is less likely to cause separation, breakage, rupture and so forth.

Moreover, with such nanocomposite structure, bidirectional solid phase dispersion occurs on the nano-scale when the metal/alloy bodies 101, 501 and the bonding part 300 are bonded. Hence, the bonding part can keep high heat resistance, bonding strength and mechanical strength over a long period, even when devices are kept operated under higher temperatures for a long duration of time, or even when used under harsh environments such as causing large temperature change between operation at high temperatures and idling at low temperatures.

Incidentally, a high temperature storage (HTS) test conducted at 280° C. revealed that the shear strength increased from approximately 40 MPa up to approximately 55 MPa over a 100-hour period after the start of test, and remained constant at around 50 MPa in the time zone beyond 100 hours.

It was also found from a temperature cycle test (TCT) conducted over a temperature range from −40 to 200° C., that the shear strength remained constant at around 35 MPa, approximately beyond the 200-th cycle and over the whole cycles thereafter (1000 cycles).

In one specific mode of the bonding part 300, the intermetallic compound may contain a low-melting-point metal ingredient, and a high-melting-point metal ingredient having a melting point higher than that of the low-melting-point metal ingredient, meanwhile the metal matrix may contain such low-melting-point metal ingredient. In this case, high heat resistance, bonding strength and mechanical strength may be maintained, cooperatively by high temperature resistance attributable to the high-melting-point metal ingredient contained in the intermetallic compound, and flexibility of the metal matrix as a result of heat softening.

The bonding part 300 also holds an advantage in that it can melt in the initial stage of melting mainly at a melting point of the low-melting-point ingredient, and that it can elevate the re-melting temperature after solidification, up to a temperature which is likely to be governed by the melting point of the high-melting-point ingredient. In other words, a large temperature hierarchy may be satisfied. It therefore becomes possible to form the bonding part 300 with high heat resistance, high reliability and high quality.

The bonding part 300 was successfully obtained from the metal particle 1 composed of 8Cu.92Sn, as described above.

The constituent materials of the metal particle 1 are, however, properly selected depending on the mating material to be bonded, which are for example at least one kind of low-melting-point metal and at least one kind of high-melting-point metal, selected from the group consisting of Cu, Al, Ni, Sn, Ag, Au, Pt, Pd, Si, B, Ti, Bi, In, Sb, Ga, Zn, Cr, Co and rare earth elements. Hence, in pursuit of obtaining the bonding part 300 with high heat resistance, high reliability and high quality, it has been necessary to repeat performance tests to determine suitable ratios by mass of the materials, every time the materials were selected.

The present inventors then conducted extensive investigations to find out an universal theory or conditions under which the bonding part 300 with high heat resistance, high reliability and high quality as described above is constantly obtainable, irrespective of the materials selected to obtain the metal particle.

As descried above, the metal particle 1 has a large number of nano-sized intermetallic compound grains that forms the nanocomposite three-dimensional structure distributed in the metal matrix, such metal particle 1 has a diameter of 10 μm or smaller, in which a part of the ingredients has already been produced the intermetallic compound in the form of mesh-like basket structure on the surface of the metal particle 1, in the process of manufacturing (improved atomizing called “nanomizing”). For example, the metal particle 1 composed of 92% by mass of Sn and 8% by mass of Cu has the basket structure of intermetallic compound Cu₆Sn₅ on and around the surface.

When the metal particle 1 with such structure, after being processed in the form of paste or sheet, is allowed to melt and then solidify, restructuring will proceed according to a mechanism below.

FIG. 7A illustrates an initial state before melting, and FIG. 7B illustrates a state of solidification after transient liquid phase sintering (TLPS).

In the initial state illustrated in FIG. 7A, the metal particle 1 has a basket structure 61 of the intermetallic compound composed of Cu₆Sn₅, and the basket structure 61 distributes in a metal matrix 62.

After melting and solidification as illustrated in FIG. 7B, the basket structure 61 of the intermetallic compound once breaks and then recombines, to produce a new three-dimensional structure 63 composed of the metallic compound in the metal matrix 62.

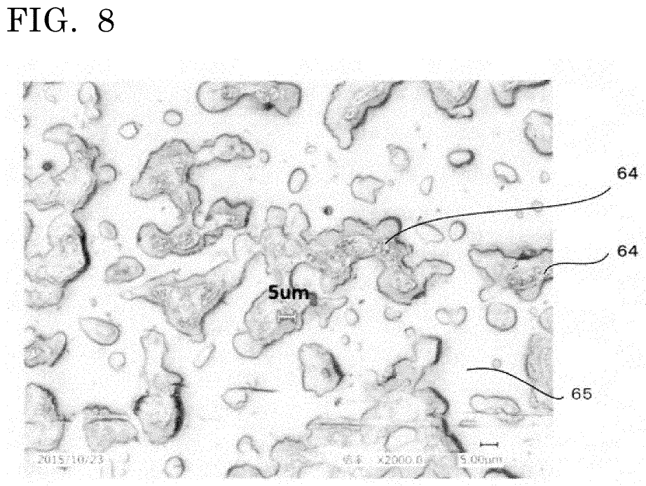

FIG. 8 is an optical microphotograph of a cross-sectional structure of the metal particle 1 composed of 92% by mass of Sn and 8% by mass of Cu, after melting and recombination.

Although seen on the cross section are grains of intermetallic compound 64 distributed like islands in a metal matrix 65, the intermetallic compound 64 is understood to form the three-dimensional structure taking the depth-wise direction into consideration.

The present inventors now reached an idea that, for successful restructuring of the three-dimensional structure composed of the intermetallic compound, through breakage and recombination of the three-dimensionally structured intermetallic compound in the metal particle 1 after melted once, the metal particle 1 could preliminarily contain a certain ratio of a restructurable three-dimensional structure of the intermetallic compound.

In other words, the present inventors contemplated that the aforementioned bonding part 300 with high heat resistance, high reliability and high quality is constantly obtainable, irrespective of the materials selected to obtain the metal particle 1, by limiting the ratio by volume occupied by the intermetallic compound in the metal particle 1, within a certain range.

Paragraphs below will describe Experiment 1 that employed Sn as the low-melting-point metal and Cu as the high-melting-point metal selected for forming the metal particle 1, and tested performances of the obtained bonding part.

In Experiment 1, numerals in the left column of a list shown later represent volume ratios of the intermetallic compound contained in the metal particle 1.

As described above, the metal particle 1 is manufactured by feeding a molten metal, which is composed of two or more kinds of selected metals with different melting points, into a forcedly created centrifugal field, and scattering the molten metal by centrifugal force to produce fine droplets.

The thus obtained metal particle 1 necessarily contain a certain ratio of the intermetallic compound in the metal matrix.

Now the metal composing the metal matrix contains the low-melting-point metal and several percent of an alloy. In Experiment 1, the low-melting-point metal is Sn, and a several percent of alloy is CuₓSn_{y}(x<y), from which the mass of metal matrix is calculable.

Also the mass of intermetallic compound is calculable from the compositional formula.

Hence, the metal particle 1, in which the intermetallic compound follows a desired volume ratio, is obtainable by suitably determine the mass of two or more selected metals.

The thus obtained metal particle 1 was then analyzed by XRD (X-ray diffractometry) in order to determine whether the intermetallic compound composing the nanocomposite three-dimensional structure satisfies the desired volume ratio in the metal particle 1.

A preform sheet was then manufactured using the metal particle as described above, and the bonding part was further formed using the preform sheet.

Performance test of the obtained bonding part was conducted by high temperature storage (HTS) test at 280° C., by which shear strength after 100-hour storage was measured.

Bonding parts showing a shear strength of smaller than 40 MPa and broken were represented by “C”, those showing a shear strength exceeding 40 MPa were represented by “B”, and those showing a shear strength exceeding 50 MPa were represented by “A”.

### [Experiment 1]

1% bonding part test C
3% bonding part test B
10% bonding part test A
15% bonding part test A
40% bonding part test A
75% bonding part test A
85% bonding part test B
90% bonding part test C

As is known from the experiment above, the bonding part with high heat resistance, high reliability and high quality is obtainable by using the metal particle 1 that contains 3% or more and 85% or less, by volume of intermetallic compound. Among them, bonding parts that further excel in heat resistance, reliability and quality were found to be obtained, by using the metal particle 1 that contains 10% or more and 75% or less, by volume, of intermetallic compound.

This invention theoretically stands on that the metal particle 1, after melted, allows therein the three-dimensionally structured intermetallic compound to be restructured, to thereby yield the bonding part with high reliability and high quality. Hence, this invention is of course applicable to combinations other than the combination of Cu and Sn, such as combinations of at least one kind of low-melting-point metal and at least one kind of high-melting-point metal selected from the group consisting of Cu, Al, Ni, Sn, Ag, Au, Pt, Pd, Si, B, Ti, Bi, In, Sb, Ga, Zn, Cr, Co, and rare earth elements.

Note that the metal particle of this invention 1 may be used not only for formation of the bonding part, but may also be used for freely selectable applications.

In conclusion, the bonding part capable of keeping high levels of heat resistance, bonding strength and mechanical strength over a long period is obtainable by the metal particle of this invention.

1. A metal particle comprising Cu and Sn,
the metal particle having a metal matrix composed of Sn—Cu alloy, and
a nano-sized intermetallic compound composed of Cu and Sn, and
the metal particle having at least inside thereof an alloyed structure in which the metal matrix and the intermetallic compound form an endotaxial junction.

2. The metal particle according to claim 1,
wherein the intermetallic compound amounts 3% or more and 85% or less in the metal particle,
in terms of ratio by volume.

3. The metal particle according to claim 2,
wherein the intermetallic compound amounts 10% or more and 75% or less in the metal particle,
in terms of ratio by volume.
